(19) United States
(12) Patent Application Publication
(10) Pub. No.: US 2023/0304745 A1
(43) Pub. Date: Sep. 28, 2023

(54) HEAT OR COLD STORAGE MULTILAYER TOWER

(71) Applicants: Alexander Levin, Binyamina (IL); Hanan-Emanuel Levin, Cailfield South (AU)

(72) Inventors: Alexander Levin, Binyamina (IL); Hanan-Emanuel Levin, Cailfield South (AU)

(21) Appl. No.: 17/586,822

(22) Filed: Jan. 28, 2022

(51) Int. Cl. F28D 20/00

(52) U.S. Cl. CPC F28D 20/0034; F28D 2020/0065

(57) ABSTRACT

A heat or cold storage multilayer tower has athermo-insulated housing with a multilayer system of rigid blocks, Each rigid block has a set of narrow vertical ducts, when these narrow ducts are alternatively open or provided with sealed flexible bags, which are ufabricated from polymer film or metal foil and contain a phase change material (PCM). The rigid block are fabricated from ceramics, glass, glass ceramics, polymer fibro reinforced concrete or glass-fiber reinforced concrete. Hydrostatic pressure of molten PCM in the sealed flexible bags ensures good thermal contact of the sealed flexible bags with internal walls of the corresponding ducts. This construction provides effective heat transfer between a heat transfer fluid (HTF) and PCM in the processes of charging and discharging of the sealed flexible bags with heat or coldwith high values of stored thermal energy for specific volume.

### BACKGROUND OF THE INVENTION

This invention relates to the area of heat or cold management systems and, specifically, to the heat or cold management systems, which include application of phase change materials (PCM).

The main field of usage of these heat or cold management systems is thermal solar power plants that apply some types of optical concentrators of solar radiation in order to achieve sufficiently high temperature of heat transfer medium flowing in the receiver of a solar collector. However, the proposed heat management system can be used in other fields, for example, for decrease of energy consumption in thermal treatment of metals.

Another important application of the proposed heat or cold management system is cold accumulation in the form of ice in large air-conditioning systems in night-time.

It is known, that heat or cold can be stored in materials in the forms of sensible heat or latent heat. A material storing sensible heat can be in liquid form (for example, water, molten salts) and a bed of solid material (for example, concrete or ceramic packing, river rocks). The bed serves as well as a heat exchanging structure.

Heat or cold storage in the latent form is performed usually by phase changes: solid-solid, solid-liquid or solid-liquid accompanied by chemical reactions (in the most cases, by reaction: dehydration-hydration).

This invention proposes a heat management tower with a packing, which can be related to solid-liquid phase change.

It should be noted, that phase-change storage allows to achieve high energy density with resulting economical advantage. Design of a phase-change storage container must provide appropriate technical solutions to problems of poor heat transfer of a phase-change material (PCM), corrosion, possible chemical reaction between the PCM and a heat transfer fluid (HTF), possible change of the PCM volume in the process of the phase change.

Technology of micro- and macro-capsulation is widely used in the modern practice in order to solve these problems.

However, this technology is very expensive and resulting specific cost of stored thermal energy is usually high.

There are some U.S. patents related to the area of heat or cold storage with application of PCM.

U.S. Pat. No. 4,086,958 describes heat exchange method and an apparatus, which are based on direct contact of two non-mixable media. Thermal contact of these media is performed by bubbling the liquid medium through the second medium, when the second medium is in the liquid phase.

U.S. Pat. No. 4,088,183 proposes a thermal energy storage housing that is designed like as a shell-and-tube heat exchanger.

U.S. Pat. No. 4,111,260 describes a thermal accumulator, which is designed as a closed vessel with a set of horizontal trays filled with PCM, when HTF flows across the outer surfaces of the PCM layers in the trays. This construction requires application of special means for holding the PCM in these trays.

U.S. Pat. No. 4,270,523 describes a heat storage apparatus with a plurality of heat exchanging elements mounted in a housing.

Each element has a central portion containing a storage medium, surrounded by portions through which a first and a second heat transfer fluids can be passed in heat contact with the storage medium.

U.S. Pat. application No. 20020000306 describes a device and method for storing thermal energy. The proposed device comprises: a) a container having inlet and outlet ports and at least one wall; b) at least one cell, this cell having two lateral sides and being placed within the aforementioned container such that the lateral sides of the cell are separated from the wall of the container; and c) at least one phase change material being capable of undergoing a phase change at a functional temperature above melting point of water at one atmosphere or pressure, this phase change material being disposed within the aforementioned cell.

In addition, U.S. Pat. Nos. 4,371,029, 4,807,696 and 6,116,330 should be noted. However, these patents do not provide a construction of a heat or cold storage, which is based on usage of ceramics or glass containers for their filling with PCM.

U.S. Pat. No. 7222569 to one author of the present invention (Alexander Levin) describes “the heat or cold storage tower, which is based on application of multi-channel blocks from ceramics, glass, glass ceramics or sulfur concrete; the parallel internal vertical channels of the blocks are open and sealed at their bottoms alternatively, and the channels with the sealed bottoms are filled partially with PCM”.

However, it is serios disadvantage of this patent that immediate contact between PCM and HTF is not prevented.

The article of Peter R. Payne “WHICH MATERIAL USES THE LEAST ENERGY?” (CHEMTECH, September 1980, pp. 550/557) demonstrates importance of application of ceramics in construction of solar collectors as a low-energycost material. Conclusions of this article are true for the case of construction of heat or cold storage plants.

### BRIEF SUMMARY OF THE INVENTION

This invention proposes such design of a heat or cold storage multilayer tower with PCM, which includes arrangement of the PCM in the form of relatively thin layers situated in flat flexible containers (bags), which are sealed and arranged in narrow compartments (ducts) of rigid blocks, when these narrow compartments alternate with narrow throughout ducts.

The rigid blocks are fabricated from ceramics, glass, glass ceramics, polymer fibro reinforced concrete or glass-fiber reinforced concrete and they are provided with sets of parallel internal vertical narrow ducts; these internal narrow ducts are open and closed alternatively at their bottoms, and the narrow ducts with the sealed bottoms are provided with flexible sealed bags filled with PCM (the thickness of the PCM layers conforms the width of the narrow ducts).

The filled flexible bags can be sealed by welding, brazing, soldering or folding.

Hydrostatic pressure of melted PCM ensures tight thermal contact of the sealed flexible bags with walls of thin vertical partitions of the vertical narrow ducts.

The height of the flexible bag is shorter than the vertical length of the narrow duct.

The internal space of each flexible bag can be provided with a flat insert with a contour that conforms the contour of the flexible bag itself. It allows to prevent crumpling of the flexible bag.

The narrow open ducts are applied for passage of liquid or gaseous heat transfer fluid (HTF) with performance of heat exchange between HTF and PCM contained in the flat flexible bags.

Heat transfer is performed in this case by thermal conductivity via thin partitions or thin walls of the rigid blocks.

These rigid blocks can be manufactured in a following way: a casting mould comprises an open box with a set of parallelepipeds fastened on the bottom of this open box with narrow gaps between the neighbouring parallelepipeds and between the parallelepipeds and the lateral walls of the open box.

The parallelepipeds have two types of their heights: with a large height and a lower height, and they are arranged alternatively on the open box’s bottom.

Concrete-glass fibro paste, concrete polymer-fibro paste, ceramic slip or molten glass are casted into the open box and fill it until a level situated between the large and lower heights of the parallelepipeds. In such a way, the parallelepipeds with the large height are not covered by liquid substance completely, and the parallelepipeds with the lower height are covered completely by this liquid substance.

After solidification, the manufactured rigid block is withdrawn from the open box and its upper section with alternatively closed and open narrow ducts serves as the lower section of the rigid block applied for containing the sealed flexible bags with PCM in its closed from underneath narrow ducts.

In another version of manufacturing the rigid blocks, these rigid blocks are fabricated with a set of open narrow parallel ducts; however, there is a ceramic, composite or metal grid, which is fastened on the bottom section of each rigid block in such a way that at least several lines of the grid are transverse to the direction of the narrow ducts in the horizontal plane.

In this case, the sealed flexible bags with PCM are arranged in some open narrow ducts, which alternate with the open narrow ducts without arrangement of these sealed flexible bags.

The frames of the metal, composite or ceramic grids are joined with the bottom sections of the lateral walls of the rigid blocks by stainless steel spring clips.

In addition, the rigid blocks of both versions (with the open narrow ducts or with the open narrow ducts, which alternate the upper open and bottom closed narrow ducts) can be provided with upper ceramic, composite or metal grids, which are joined with the upper sections of the lateral walls of the rigid blocks by stainless steel spring clips.

It prevents falling out of the sealed flexible bags with PVM from the narrow ducts.

PCM can contain a filler for improving thermal conductivity or another filler comprising a nucleating agent, or a combination thereof.

Each sealed flexible bag can be joined with an upper crossbar when the terminal sections of this crossbar somewhat protruded from the contour of the sealed flexible bag. It gives possibility to hang the flexible bag in its narrow duct with supporting of the terminal sections of the crossbar upon the upper edge of the rigid block.

For such sealed flexible bags provided with the upper crossbars, the ceramic, composite or metal grid is installed upon the upper section of the rigid block with its sealed flexible bags filled with PCM maintained in a part of its narrow ducts.

The rigid blocks of the second version (with the open narrow ducts) can be fabricated with usage of extrusion as in the case of fabrication of honeycomb ceramic blocks.

The rigid blocks can be produced from materials (ceramics, glass, glass-fibro reinforced concrete or polymer fibro reinforced concrete) with high values of emissivity in the infrared range of electro-magnetic radiation. Analogically, the flexible bags can be fabricated from material with high values of emissivity in the infrared range of electro-magnetic radiation or provided with raven black coatings of their external surfaces.

It improves heat exchange between the rigid blocks and the sealed flexible bags installed in them, and, therefore, heat exchange between PCM in the sealed flexible bags and HTF passing via the open narrow ducts.

It is important advantage of the described heat or cold storage system that the rigid blocks serve at the same time as very effective heat exchanging units.

The housing of the heat or cold storage multilayer tower is provided with inlet and outlet connections.

The abovementioned rigid blocks are situated in the heat or cold storage multilayer tower in the form of one or more layers supported by supporting grids, which, in turn, are positioned on supporting rings.

When HTF is liquid, the heat or cold storage multilayer tower can be provided with one or several liquid distributors.

### BRIEF DESCRIPTION OF THE SEVERAL VIEWS OF THE DRAWING

FIG. 1a is a vertical cross-section of a metal mold for fabrication of rigid blocks with narrow ducts, which are alternatingly open and closed at their bottoms.

FIG. 1b is a view from above of the metal mold for fabrication of the rigid blocks with narrow ducts, which are alternatingly open and closed at their bottoms.

FIG. 1c shows the vertical cross-section of the metal mold with a filling fluidly material.

FIG. 1d and FIG. 1e are a vertical cross-section and a view from above of the fabricated rigid block with narrow ducts, which are alternatingly open and closed at their bottoms.

FIG. 2a and FIG. 2b are horizontal and vertical cross-sections of the rigid block with the alternative arrangement of open narrow ducts and the semi-open ducts, which are closed at their bottoms and provided with sealed flexible bags containing PCM.

FIG. 3a is a vertical cross-section of a rigid block with a set of narrow open ducts.

FIG. 3b and FIG. 3c are a vertical cross-section and a view from below of a grid applied for holding of sealed flexible bags with PCM in a part of the narrow ducts of the rigid block.

FIG. 3d is a vertical cross of the rigid block with the set of the narrow open ducts, when a part of the narrow open ducts is provided with the sealed flexible bags containing PCM and the grid is installed on the bottom section of the rigid block.

FIG. 3e is a view from above of the rigid block with the set of the narrow open ducts, when a part of the narrow open ducts is provided with the flexible bags containing PCM and the grid is installed on the bottom section of the rigid block.

FIG. 4a and FIG. 4b are vertical longitudinal and transverse cross-sections of a sealed flexible bag with a flat insert shaped as a frame.

FIG. 5a and FIG. 5b are vertical longitudinal and transverse cross-sections of a sealed flexible bag with a crossbar joined with the upper edge of the sealed flexible bag.

FIG. 6a is a vertical cross of the rigid block with the set of the narrow open ducts, when a part of the narrow open ducts is provided with sealed flexible bags containing PCM and joined with crossbars at their upper edges; these sealed flexible bags are hanged on the crossbars, which are supported on the upper edge of the rigid block. There is a grid that covers the upper section of the rigid block.

FIG. 6b is a view from above of the rigid block according FIG. 6a.

FIG. 7a shows a vertical cross-section of a heat or cold storage multilayer tower with an arrangement of rigid blocks provided with sealed flexible bags containing PCM.

FIG. 7b shows a lateral detail section I of the heat or cold storage multilayer tower with the arrangement of the rigid blocks provided with the sealed flexible bags containing PCM.

### DETAILED DESCRIPTION OF THE INVENTION

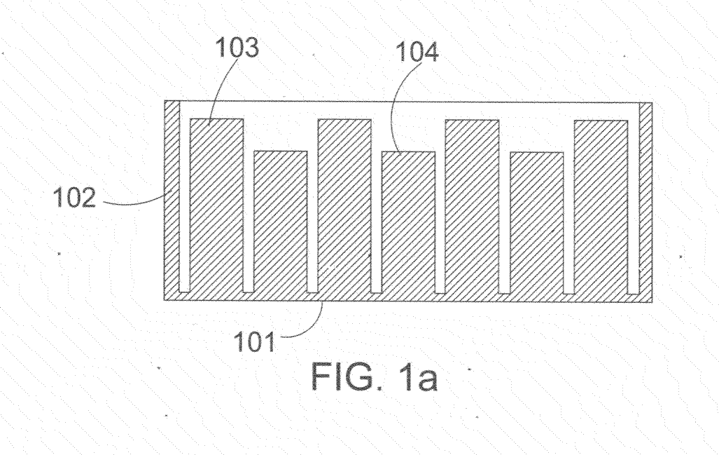

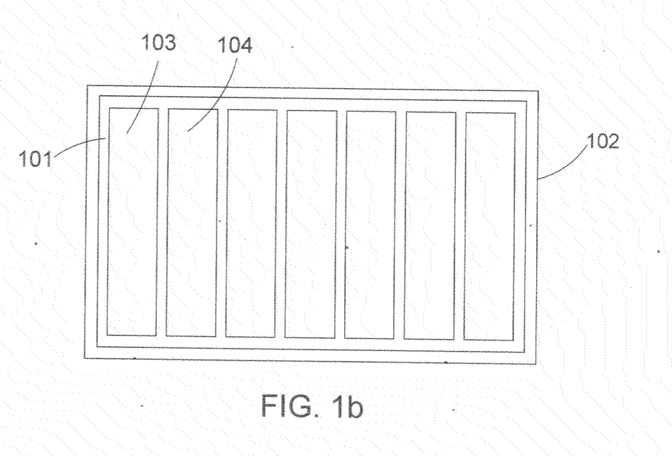

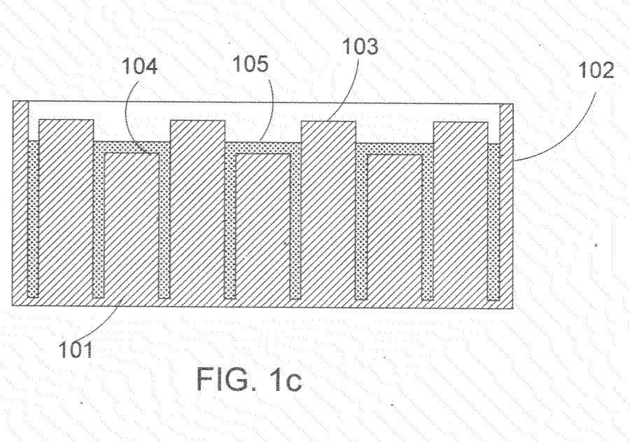

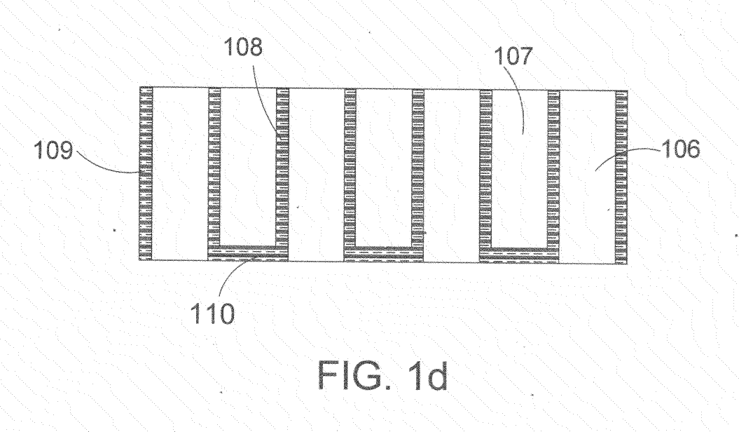

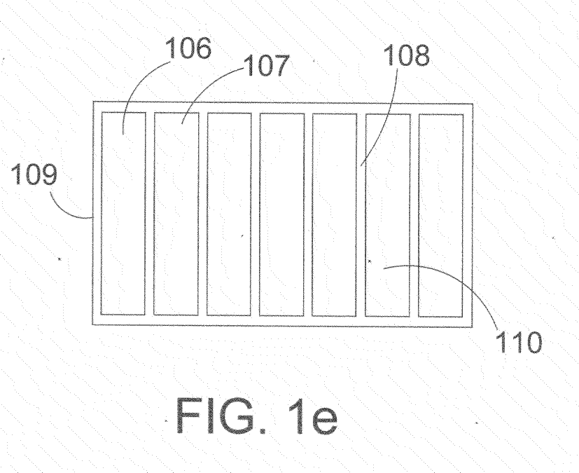

FIG. 1a is a vertical cross-section of a metal mold for fabrication of rigid blocks with narrow ducts, which are alternatingly open and closed at their bottoms.

It comprises a bottom section 101, walls 102, parallelepipeds 103 of a large height, parallelepipeds 104 of a lower height.

FIG. 1b is a view from above of the metal mold for fabrication of the rigid blocks with the narrow ducts, which are alternatingly open and closed at their bottoms.

It comprises the bottom section 101, walls 102, parallelepipeds 103 of the large height, parallelepipeds 104 of the lower height.

FIG. 1c shows the vertical cross-section of the metal mold with a filling fluidly material.

It comprises the bottom section 101, walls 102, parallelepipeds 103 of the large height, parallelepipeds 104 of the lower height and the fluidly filling material 105.

FIG. 1d and FIG. 1e are a vertical cross-section and a view from above of the rigid block fabricated after solidification of the fluidly filling material; it comprises narrow ducts 106 and 107, which are alternatively open and closed at their bottoms and divided by partitions 108, lateral walls 109 and bottom sections 110.

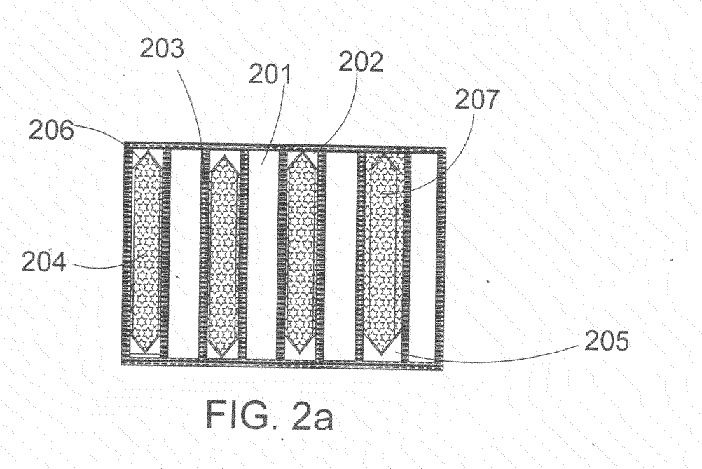

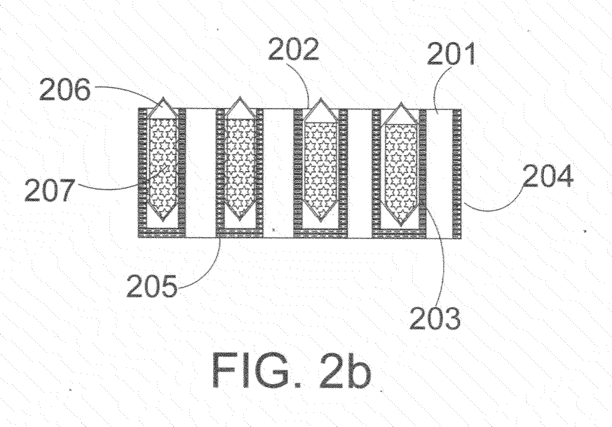

FIG. 2a and FIG. 2b are horizontal and vertical cross-sections of the rigid block with the alternative arrangement of open narrow ducts and the semi-open ducts, which are closed at their bottoms and provided with sealed flexible bags containing PCM.

It comprises the alternatively open and closed at their bottoms narrow duct 201 and 202, which are divided by partitions 203, lateral walls 204, bottom sections 205, flexible sealed bags 206 with PCM 207 .

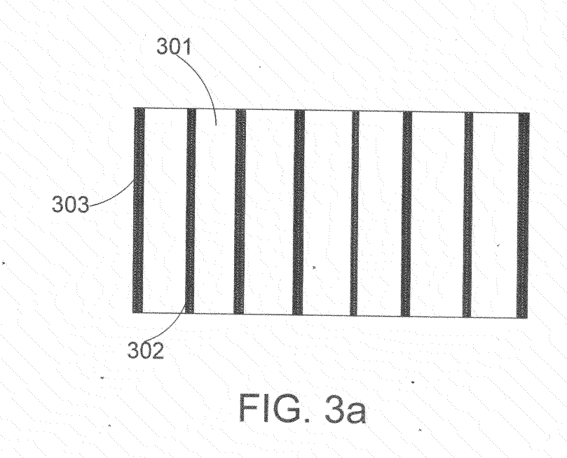

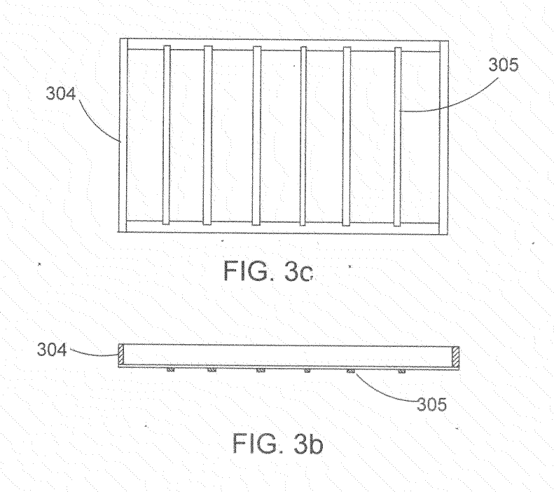

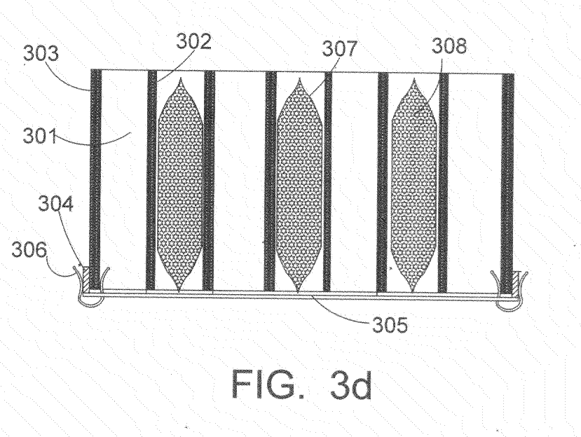

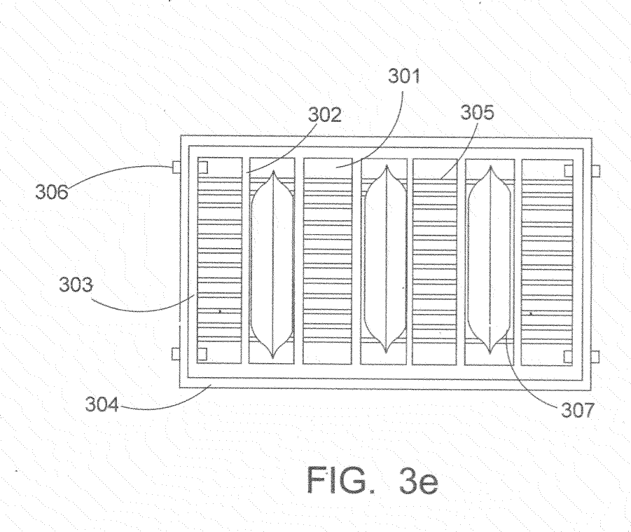

FIG. 3a is a vertical cross-section of a rigid block with a set of narrow open ducts.

It comprises the open narrow ducts 301 divided by partitions 302 and lateral walls 303.

FIG. 3b and FIG. 3c are a vertical cross-section and a view from below of a grid applied for holding of sealed flexible bags with PCM in a part of the narrow ducts.

They comprise frame 304 lines 305 of the grid.

FIG. 3d is a vertical cross of the rigid block with the set of the narrow open ducts, when a part of the narrow open ducts is provided with the flexible bags containing PCM and the grid is installed on the bottom section of the rigid block.

It comprises: frame 304; lines 305 of the grid; the open narrow ducts 301 of the rigid block, which are divided by partitions 302; the lateral walls 303; the grid is fastened on the bottom section of the rigid block by stainless steel spring clips 306.

The sealed flexible bags 307 are provided with PCM 308.

FIG. 3e is a view from above of the rigid block with the set of the narrow open ducts, when a part of the narrow open ducts is provided with the sealed flexible bags containing PCM and the grid is installed on the bottom section of the rigid block.

It comprises: frame 304; lines 305 of the grid; the open narrow ducts 301 divided by partitions 302; the lateral walls 303; this grid is fastened on the bottom section of the rigid block by the stainless steel spring clips 306.

The sealed flexible bags 307 are provided with PCM.

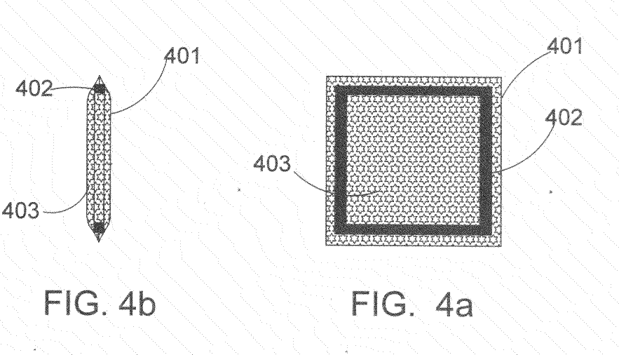

FIG. 4a and FIG. 4b are vertical longitudinal and transverse cross-sections of a sealed flexible bag with a flat insert shaped as a frame.

They comprise the sealed flexible bag 401 itself, a rigid insert shaped as frame 402 and PCM 403.

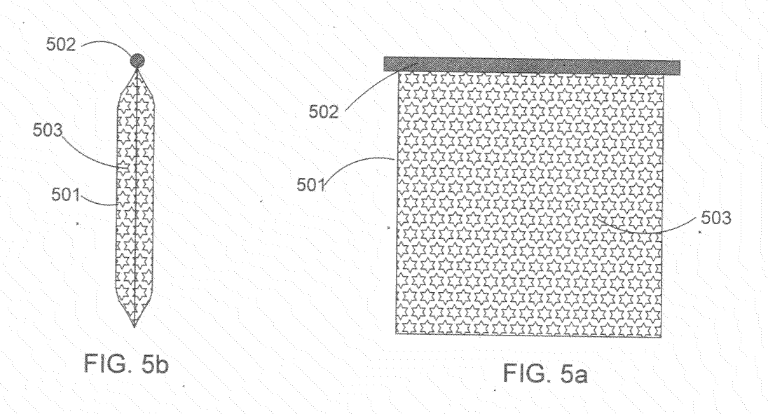

FIG. 5a and FIG. 5b are vertical longitudinal and transverse cross-sections of a sealed flexible bag with a crossbar joined with the upper edge of the sealed flexible bag.

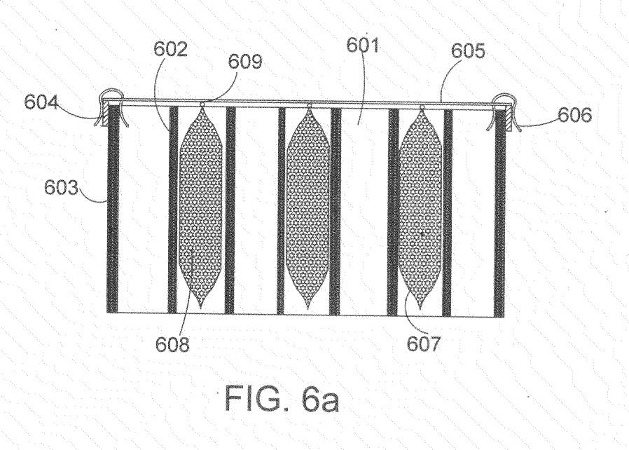

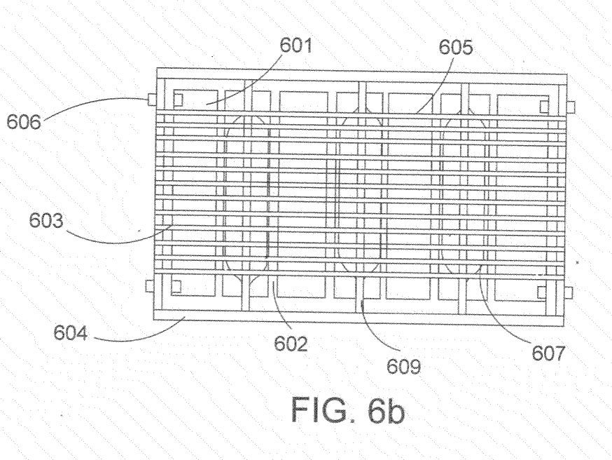

FIG. 6a is a vertical cross of the rigid block with the set of the narrow open ducts, when a part of the narrow open ducts is provided with the sealed flexible bags containing PCM and joined with crossbars at their upper edges; these sealed flexible bags are hanged on the crossbars, which are supported on the upper edge of the rigid block. There is a grid that covers the upper section of the rigid block.

It comprises: frame 604 and lines 605 of the grid; open narrow ducts 601, which are divided by partitions 602 of the rigid block; the lateral walls 603 of the rigid block; the grid is fastened on the upper section of the rigid block by stainless steel spring clips 606. The sealed flexible bags 607 with PCM 608 and upper crossbars 609 are hanged on crossbars 609 in a part of the open narrow ducts 601.

Crossbars 609 are supported by the lateral walls 603 of the rigid block.

FIG. 6b is a view from above of the rigid block according the FIG. 6a.

It comprises: frame 604 and lines 605 of the grid; open narrow ducts 601, which are divided by partitions 602 of the rigid block; the lateral walls 603 of the rigid block; the grid is fastened on the upper section of the rigid block by stainless steel spring clips 606. The sealed flexible bags 607 and upper crossbars 609 are hanged by crossbars 609 in a part of the open narrow ducts 601.

Crossbars 609 are supported by the lateral walls 603 of the rigid block.

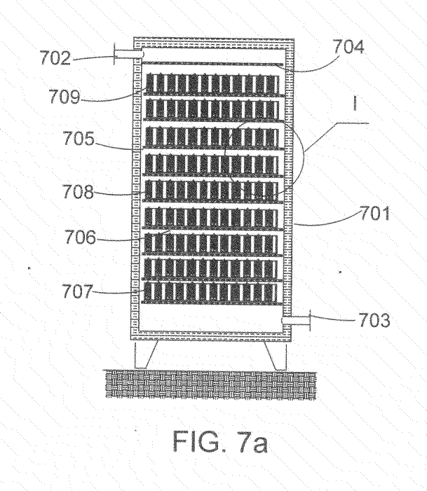

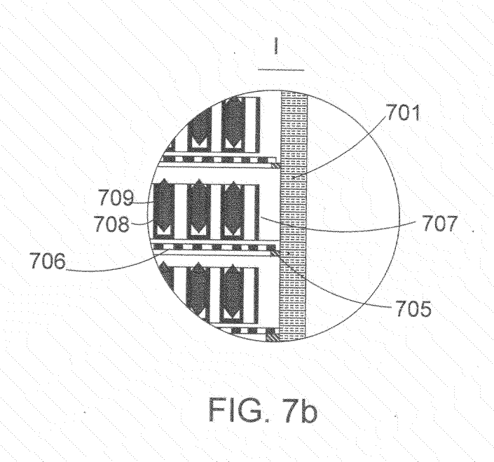

FIG. 7a shows a vertical cross-section of a heat or cold storage multilayer tower with arrangement of rigid blocks provided with sealed flexible bags containing PCM.

It comprises: a thermo-insulated housing 701 with inlet and outlet connections 702 and 703; distributor 704; supporting rings 705; perforated supporting plates 706; rigid blocks 707 and sealed flexible bags 708 filled with PCM 709.

FIG. 7b shows a lateral detail section I of the heat or cold storage multilayer tower with arrangement of rigid blocks provided with sealed flexible bags containing PCM.

It comprises: the thermo-insulated housing 701; supporting rings 705; perforated supporting plates 706; rigid blocks 707 and the sealed flexible bags 708 filled with PCM 709.

### REFERENCES CITED

U.S. Pat. Documents

| | |
|---|---|
| 4086958 | May 1978 Lindner et al. |
| 4088183 | May 1978 Anzai et al. |
| 4111260 | September 1978 Bricard et al. |
| 4234782 | November 1980 Barabas et al. |
| 4241782 | December 1980 Schoenfelder |
| 4270523 | June 1981 van Heel |
| 4286574 | September 1981 Vrolyk et al. |
| 4371029 | February 1983 Lindner et al. |
| 4408659 | October 1983 Hermanns et al. |
| 4524756 | June 1985 Laverman |
| 4807696 | February 1989 Colvin et al. |
| 4993481 | February 1991 Kamimoto et al. |
| 6037032 | March 2000 Klett et al. |
| 6116330 | September 2000 Salyer |
| 7222659 | May 2007 Levin |
| 2002/0000306 | January 2002 Bradley |

Foreign Patent Documents

| | |
|---|---|
| 57-204796 | December 1982 JP |

### OTHER REFERENCES

Peter R. Payne, Which material uses the least energy?, Chemtech, September 1980, pp. 550-557. cited by other.

1. A heat or cold storage multilayer tower comprising: a thermo-insulated housing provided with inlet and outlet connections for feeding and withdrawal of a heat transfer fluid (HTF) from said heat or cold storage multilayer tower;
said housing includes several layers of rigid blocks, wherein each said rigid block comprises a set of narrow vertical ducts, which are arranged alternatively with a set of narrow compartments; said narrow compartments are closed at their bottoms and open from above; there are sealed flexible bags, which are arranged in said narrow compartments of said rigid blocks with tight thermal contact between their flexible walls and partitions or internal walls of said rigid blocks; the height of each sealed flexible bag is lower that the vertical length of the narrow ducts; said sealed flexible bags contain phase change material (PCM) and said narrow ducts serve for passage of heat transfer fluid (HTF); said rigid blocks are fabricated from ceramics, glass, glass ceramics, polymer fibro reinforced concrete or glass-fiber reinforced concrete.

2. The heat or cold storage multilayer tower as claimed in claim 1, wherein HTF is a liquid medium and the thermo-insulated housing is provided with a distributor of HTF.

3. The heat or cold storage multilayer tower as claimed in claim 1, wherein the thermo-insulated housing comprises at least one redistributor arranged between the layers of the rigid blocks.

4. The heat or cold storage multilayer tower as claimed in claim 1, wherein each sealed flexible bag is provided with a rigid flat insert with a contour, which conforms the contour of said sealed flexible bag.

5. A heat or cold storage multilayer tower comprising: a thermo-insulated housing provided with inlet and outlet connections for feeding and withdrawal of a heat transfer fluid (HTF) from said heat or cold storage multilayer tower; said thermo-insulated housing includes several layers of rigid blocks, wherein each said rigid block comprises a set of narrow vertical ducts, and said narrow vertical ducts are open or provided with sealed flexible bags alternatively; the height of each sealed flexible bag is lower that the vertical length of said narrow ducts; said sealed flexible bags are in tight thermal contact between their flexible walls and partitions or internal walls of said rigid blocks; said sealed flexible bags contain phase change material (PCM); there is a ceramic, composite or metal grid, which is fastened upon the lower section of each said rigid block in such a way that at least several lines of said ceramic, composite or metal grid are transverse to the direction of said narrow ducts in the horizontal plane;; the frame of the said ceramic, composite or metal grid is joined with the lower section of the lateral walls of said rigid block by stainless steel spring clips; said rigid blocks are fabricated from ceramics, glass, glass ceramics, polymer fibro reinforced concrete or glass-fiber reinforced concrete.

6. The heat or cold storage multilayer tower as claimed in claim 5, wherein HTF is a liquid medium and the thermo-insulated housing is provided with a distributor of HTF.

7. The heat or cold storage multilayer tower as claimed in claim 5, wherein the thermo-insulated housing comprises at least one redistributor arranged between the layers of the rigid blocks.

8. The heat or cold storage multilayer tower as claimed in claim 5, wherein each sealed flexible bag is provided with a rigid flat insert with a contour, which conforms the contour of said sealed flexible bag.

9. A heat or cold storage multilayer tower comprising: a thermo-insulated housing provided with inlet and outlet connections for feeding and withdrawal of a heat transfer fluid (HTF) from said heat or cold storage multilayer tower; said thermo-insulated housing includes several layers of rigid blocks, wherein each said rigid block comprises a set of narrow vertical ducts; said narrow vertical ducts are open or provided with sealed flexible bags alternatively; the height of each sealed flexible bag is lower that the vertical length of said narrow ducts; said sealed flexible bags are in tight thermal contact between their flexible walls and partitions or internal walls of said rigid blocks; said sealed flexible bags contain phase change material (PCM); said sealed flexible bags are joined with crossbars at their upper edges; said flexible bags are hanged on said crossbars, which are supported upon the upper edge of said rigid block; there is a grid that covers the upper section of said rigid block; a frame of said grid is fastened on the walls of said rigid block by stainless steel spring clips; said rigid blocks are fabricated from ceramics, glass, glass ceramics, polymer fibro reinforced concrete or glass-fiber reinforced concrete.

10. The heat or cold storage multilayer tower as claimed in claim 9, wherein said HTF is a liquid medium and the thermo-insulated housing is provided with a distributor of HTF.

11. The heat or cold storage multilayer tower as claimed in claim 9, wherein the thermo-insulated housing comprises at least one redistributor arranged between said layers of said rigid blocks.

12. A heat or cold storage multilayer tower as claimed in claim 9, wherein the rigid blocks are provided with a ceramic, composite or metal grids, which are fastened on the upper sections of said rigid blocks in such a way that at least several lines of each said ceramic, composite or metal grid are transverse to the direction of the narrow ducts of its rigid block in the horizontal plane; the frames of the said ceramic, composite or metal grids are joined with the upper sections of the lateral walls of said rigid blocks by stainless steel spring clips.
